(19) United States
(12) Patent Application Publication
(10) Pub. No.: US 2026/0065558 A1
(43) Pub. Date: Mar. 5, 2026

(54) TECHNIQUE FOR SPECTRAL MAP-BASED IMAGE GENERATION FROM ENERGY-RESOLVED MEDICAL IMAGING

(71) Applicant: Siemens Healthineers AG, Forchheim (DE)

(72) Inventors: Alexis LAUGERETTE, Hoechstadt A. D. Aisch (DE); Lars BOHN, Neunkirchen am Brand (DE); Felix DINGELDEY, Erlangen (DE); Bjoern NOLTE, Fuerth (DE)

(73) Assignee: Siemens Healthineers AG, Forchheim (DE)

(21) Appl. No.: 19/316,054

(22) Filed: Sep. 2, 2025

(30) Foreign Application Priority Data
Sep. 3, 2024 (DE) 10 2024 208 328.3

(51) Int. Cl. G06T 11/00; G06F 40/40

(52) U.S. Cl. CPC G06T 12/10; G06F 40/40; G06T 2200/24; G06T 2210/41

(57) ABSTRACT

A computer-implemented method, performed by a computing device, comprises: receiving raw multispectral medical imaging data, which was acquired via an energy-resolved medical imaging technique; determining a scope of analysis of the raw multispectral medical imaging data; selecting at least one spectral map based on the scope of analysis; and processing the raw multispectral medical imaging data to generate at least one medical image based on the at least one spectral map.

### CROSS-REFERENCE TO RELATED APPLICATION(S)

The present application claims priority under 35 U.S.C. § 119 to German Patent Application No. 10 2024 208 328.3, filed Sep. 3, 2024, the entire contents of which is incorporated herein by reference.

### FIELD

One or more example embodiments of the present invention relate to a technique for generating a medical image from a spectral map generated from raw multispectral medical imaging data acquired via an energy-resolved medical imaging technique, in particular comprising a method, a computing device, a system comprising the computing device, and a non-transitory computer program product.

### BACKGROUND

Photon-counting computed tomography (CT) is a form of CT, in which X-rays are detected using a photon-counting detector, which registers the interactions of individual photons. By keeping track of the deposited energy in each interaction, the detector pixels of the detector each record an approximate energy spectrum, making it a spectral or energy-resolved CT technique.

In the clinical use-case, photon-counting can offer major advantages. Compared with images from conventional CT scanners, clinical images generated using photon-counting detectors feature a high resolution and contrast improvements. The technology also paves the way for decisive further reductions in X-ray dose during CT scans. Imaging with photon-counting detectors therefore puts less strain on patients and offers physicians a genuine alternative when it comes to screening programs and follow-up examinations, for example in cancer treatment. Moreover, due to its inherently energy-resolved nature, multi-spectral CT data offers an additional dimension. It redefines clinical decision-making by providing all relevant CT results with one single scan.

However, in the clinical routine, that is, in routine reading of medical images, it becomes very challenging to unlock the full potential of multispectral images. This is because the additional dimension in the data also adds an additional dimension to the decision-making process of a clinician in the reading of multispectral medical images. The clinician conventionally has to select appropriate spectral ranges and apply the right image processing tools to be able to draw the correct conclusions. Missing out here conventionally may mean missing out on clinically relevant findings with potentially severe consequences for the patient.

### SUMMARY

It is therefore an object of one or more example embodiments of the present invention to provide a solution for improving image generation based on raw multispectral medical imaging data, in particular in terms of higher resolution and/or improved contrast. Alternatively or in addition, an object of one or more example embodiments of the present invention is to provide the clinician with credible assistance by automatedly processing multi-spectral image data for providing an improved medical diagnosis and/or for allowing for improved decision making in view of a potential treatment plan. Alternatively or in addition, an object of one or more example embodiments of the present invention is to enable improvements in medical image acquisition (e.g., in view of a reduced acquisition time and/or need for only a single scan compared to conventional, e.g., pairwise, scans), reductions in radiation doses, and/or reductions in administering contrast agents, leading to a reduced health risk and/or strain for the patient.

At least one or more objects of one or more example embodiments of the present invention is/are solved by a method for generating a medical image from a spectral map generated from raw multispectral medical imaging data acquired via an energy-resolved medical imaging technique, by a computing device, by a system, by a computer program (and/or computer program product), and a non-transitory computer-readable storage medium according to the appended independent claims. Advantageous aspects, features and embodiments are described in the dependent claims and in the following description together with advantages.

In the following the solution according to embodiments of the present invention is described with respect to the claimed method for generating a medical image from a spectral map generated from raw multispectral medical imaging data acquired via an energy-resolved medical imaging technique as well as with respect to the claimed computing device. Features, advantages or alternative embodiments herein can be assigned to the other claimed objects (e.g., the system, the computer program or a computer program product) and vice versa. In other words, claims for the computing device and/or the system can be improved with features described or claimed in the context of the method. In this case, the functional features of the method are embodied by structural units of the system and vice versa, respectively.

As to a first aspect, a (in particular computer-implemented) method for generating a medical image from a spectral map generated from raw multispectral medical imaging data acquired via an energy-resolved medical imaging technique is provided. The method is performed by a computing device. The method comprises a step of receiving raw multispectral medical imaging data. The raw multispectral medical imaging data have been acquired via an energy-resolved medical imaging technique. The method further comprises a step of determining a scope of analysis of the received raw multispectral medical imaging data. The method further comprises a step of selecting at least one spectral map based on the determined scope of analysis. The method still further comprises a step of processing the received raw multispectral medical imaging data for generating at least one medical image based on the at least one selected spectral map. Alternatively or in addition, at least one medical image may be generated based on or using the at least one spectral map (e.g., by processing the at least one spectral map or by applying the at least one spectral map to the raw multispectral medical imaging data in the step of processing the same).

According to some examples, a plurality of spectral maps may be preconfigured and the step of selecting may comprise selecting the at least one spectral map from the plurality of preconfigured maps. Each spectral map from the plurality of spectral maps may be associated with a different scope of analysis. According to some examples, the step of selecting may comprise comparing the determined scope of analysis with the associated scopes of analysis of the preconfigured spectral maps.

According to some examples, the spectral maps may be generated from the raw multispectral medical imaging data.

By the inventive technique, raw multispectral medical imaging data acquired via a spectral and/or energy-resolved medical imaging technique can be automatically processed (and/or processed by computer-implementation). The resulting medical images have a higher resolution and/or improved contrast compared to conventional medical images acquired without energy-resolution. The acquisition of the raw multispectral medical imaging data has the advantage that all relevant data can be acquired in a single scan and/or with a reduced need for radiation, e.g., with an overall X-ray dose that is lower than conventionally.

According to some examples, a spectral map may correspond to a given spectral range. The inventive technique enables selecting a suitable spectral range for diagnosis and/or decision making, and/or selecting suitable image processing tools, in particular automatically and/or in a computer-implemented way.

The energy-resolved medical imaging technique may comprise (or may be) computed tomography (CT), in particular photon-counting CT. Alternatively or in addition, the energy-resolved medical imaging technique may comprise (or may be) magnetic resonance tomography (MRT), such as MRT with two or more different B0 fields or MRT with variable acquisition sequences with using different magnetic field strengths. Further alternatively or in addition, the energy-resolved medical imaging technique may comprise (or may be) energy-resolved neutron imaging (e.g., using the energy-resolved neutron imaging system RADEN as described in [8], which is included herein by reference). Still further alternatively or in addition, the energy-resolved medical imaging technique may comprise (or may be) dual-energy X-ray imaging, photon-counting X-ray imaging, phase-contrast X-ray imaging, and/or energy-resolved X-ray imaging (e.g., as described in [9], which is included herein by reference). X-ray imaging may also be denoted as (e.g., digital) radiography and/or may comprise (in particular two-dimensional, 2D) projection imaging. Any X-ray imaging technique may be similar to (and/or may use the same technique as) CT, but for conventional radiography, allowing the generation of several contrasts with one image acquisition only.

The energy-resolved medical imaging technique may alternatively or in addition comprise (or may be) photoacoustic imaging (also: optoacoustic imaging), which may be energy resolved in the sense that different wavelengths, e.g., energy levels of visible and/or near infrared light (e.g., provided by non-ionizing laser pulses), are used to acquire the medical imaging data.

The energy-resolved medical imaging technique may comprise a combination of two different energy-resolved medical imaging techniques, e.g., photon-counting CT and (in particular energy-resolved) MRT.

The raw multispectral medical imaging data may pertain to a patient and/or a (in particular living) individual, a human and/or an animal.

The raw multispectral medical imaging data may, e.g., comprise an amount of energy deposition per unit area, such as for single-photon CT. The energy deposition may correspond to the energy of a single photon (and/or a single neutron), which is proportional to its wavelength (and/or “spectral” colour). The amount of energy deposition may be measured exactly, or per predetermined energy bin. The unit area may be a pixel of the (e.g., X-ray) detector.

The raw multispectral medical imaging data may be captured by using multispectral imaging capturing data at different wavelengths, each of which interacts differently with biological tissues. For instance, different wavelengths can penetrate tissues to varying depths, revealing details that may not be visible at other wavelengths.

The raw multispectral medical imaging data may, e.g., comprise k-space data acquired by an MRT scanner.

By the spectral data, tissue types may be distinguished based on their specific energy absorption characteristics (in particular for CT) and/or based on their specific Larmor frequency (in particular for MRT).

The scope of analysis of the received raw multispectral medical imaging data may comprise a dataset (or may be comprised in a dataset), indicating a medical use case and/or a reason why the medical imaging was performed, such as a dataset indicating an anatomical structure and/or a region of interest (RoI) to be imaged, for example in view of a potential diagnosis and/or in view of symptoms described by a patient. According to some examples, the analysis may happen at the computing device and/or involve the inspection of the medical image by a user. In particular, the medical image may be conceived as being prepared for an inspection by the user according to the scope of the analysis. According to some examples, the scope of analysis may comprise a text string or any other identifier, such as a computer readable code or number, e.g., identifying a medical use case and/or reason for exam and/or medical procedure and/or medical question or task. According to some examples, the scope of analysis may comprise an ICD code. Thereby, ICD stands for International Classification of Diseases. The International Classification of Diseases is a globally used medical classification used in epidemiology, health management and for clinical purposes, maintained by the WHO.

The at least one spectral map (briefly also: map) may comprise a predetermined functional dependence of the resolved energy and/or spectrum per unit area or unit volume (e.g., per pixel or per voxel). Each spectral map may comprise a different predetermined functional dependence. Thus, a spectral map may be seen as transfer function configured to map raw multispectral medical imaging data to a representation or medical image data of the multispectral medical imaging data of a predefined spectral range. According to some examples, the representation or medical image may be mono-spectral or monoenergetic at a pre-defined mono-spectral and/or mono-energy (keV) level. That way, the spectral map may also be conceived as a selective spectral filter of the raw multispectral medical imaging data.

According to some examples, the spectral mal may comprise a virtual representation or image of the raw multispectral medical imaging data at a predefined spectral/energy range or level. According to some examples, the virtual representation or image of the multispectral medical imaging data may be generated by applying the functional dependence or transfer function to the raw multispectral medical imaging data.

For raw multispectral medical imaging data by CT, a spectral map may, e.g., comprise a virtual monoenergetic image at a predefined mono-energy (keV) level, an iodine map, an effective atomic number map, a virtual unenhanced map, and/or a virtual non-contrast map, as further described in [1], [2], [3], [4], all of which are included herein by reference.

For raw multispectral medical imaging data by MRT, a spectral map may, e.g., comprise a (e.g., magnitude-based or complex-based) proton density fat-fraction (FF) map, a B0 map, an R2* map (e.g., from short-TE train or from all echoes with FF compensation), an unwrapped phase map, a susceptibility weighted imaging (SWI) map, a local frequency shift (LFS) map, a quantitative susceptibility mapping (QSM) map, a contrast map, a T1 relaxation time map, a T2 relaxation time map, and/or a T2p map, as further described in [5], [6], [7], all of which are included herein by reference.

The selection of at least one spectral map may depend on a medical use case (e.g., as the scope of analysis). For example, an iodine map of raw multispectral CT data may be suitable for myocardial perfusion, pulmonary embolism, and/or pulmonary vein imaging. As a further example, a lesion in a pancreatic body may be advantageously visualized in a 50 keV mono-energetic image, an iodine concentration overlay map, and/or an effective atomic number map. As a further example, a kidney stone may be best characterized by an effective atomic number map.

According to some examples, the method may further comprise generating the at least one spectral map according to the selected spectral map.

The generating of the at least one spectral map may comprise applying the predetermined functional dependence of the resolved energy and/or spectrum per unit area or unit volume (e.g., per pixel or per voxel) to the raw multispectral medical imaging data.

The result, i.e., the spectral map, may be a virtual representation of the raw multispectral medical imaging data in a predefined spectral range or level (which representation still needs to be processed/converted/rendered to obtain the medical image).

The processing may comprise converting the at least one spectral map into at least one medical image (briefly also: image). The at least one medical image may be a volumetric image (also: three-dimensional, 3D, image) or a planar image (also: two-dimensional, 2D, image). The planar image may, e.g., be associated with a slice of a volumetric medical imaging dataset comprising the raw multispectral medical imaging data.

The generated medical image may be provided for rendering, e.g., on a screen, on a head-mounted display (HMD), and/or on an extended reality (XR) headset. The screen may be screen (e.g., a touchscreen) of a computing device, such as a PC, a mobile device and/or a tablet.

The raw multispectral medical imaging data may comprise a time series. In this case, the medical image may comprise a time series as well (e.g., a video sequence).

Alternatively or in addition, there exist various CT methods for acquiring multispectral imaging data, such as dual energy CT and/or photon-counting CT.

There exist various MRT methods for acquiring multispectral imaging data, such as using two different magnets to perform successive measurements with two different B0-field values and/or applying specifically designed excitation pulse sequences.

Each of the energy-resolved medical imaging techniques can provide data that are improved, e.g., due to the patient naturally remaining in the same position, as opposed to performing conventionally two different measurements. Moreover, less contrast agents may be dispensed and a radiation dose that the patient is subjected to may be reduced, which benefits the patient's health.

The method may further comprise a step of determining a spectral range, a body part and/or at least one RoI of the received raw multispectral medical imaging data. Optionally, the determining may be based on metadata of the received raw multispectral medical imaging data. Alternatively or in addition, the determining may be based on voxel data, or pixel data, of the received raw multispectral medical imaging data. The determining may in particular be based on a machine-learned function.

Alternatively or in addition, the method may comprise a step of receiving a user input indicative of a spectral range, a body part, and/or at least one RoI, of the received raw multispectral medical imaging data.

According to some examples, the step of selecting may comprise selecting the spectral map according to the spectral range. According to some examples, the step of generating may comprise generating the spectral map based on the spectral range.

Determining the scope of analysis may be based on the spectral range, the imaged body part, and/or at least one RoI. The corresponding data may be determined automatically and/or by a computing device (e.g., the computing device performing the method). Such a determining may be based on metadata of the raw multispectral medical imaging data (e.g., a DICOM-header), and/or it may be based on an analysis of the semantic content, in particular by applying a machine-learned function to the raw multispectral medical imaging data. Thereby, the method may be (e.g., completely or at least predominantly) computer-implemented.

Determining the body part and/or the RoI may be performed via an anatomy aware algorithm. An anatomy-aware algorithm may be an algorithm designed with a deep understanding of (in particular human) anatomy, allowing it to analyze, process, or predict medical data in a way that aligns with anatomical structures and relationships.

The at least one RoI may be voxel-based or pixel-based. Alternatively or in addition, the at least one RoI may have a predetermined geometric shape, e.g., according to a bounding box, a rectangle, a circle, an ellipse, a cube, and/or a sphere.

The scope of analysis may be based on a user input. E.g., the body part and/or at least one RoI, to which the raw multispectral medical imaging data relate, may be provided by the user input. This can enable the user (e.g., a medical practitioner) to provide a scope that deviates from the content provided by the metadata.

The user input may be received via a user interface (UI), e.g., a graphical user interface (GUI). The UI (and/or GUI) may comprise a computer mouse, a joystick, a touchpad, a keyboard, a touchscreen, and/or a microphone (in particular for receiving audio user input and/or verbal instructions for modifying the rendering).

Determining the scope of analysis may comprise analysing metadata in relation to the raw multispectral medical imaging data, in particular from a worklist, from a scheduling system, from a scan protocol, from an electronic medical record (EMR) database (also: electronic health record, EHR, database), from demographic data and/or from (and/or in relation to) a disease or patient history, in particular of the patient (and/or individual) to whom the raw multispectral medical imaging data pertain. For example, information about the clinical indication (and/or reason for examination; also: reason for the acquisition of the raw multispectral medical imaging data) or about findings reported in prior examinations (briefly: exams) may be used.

Alternatively or in addition, determining the scope of analysis may comprise using the determined spectral range, the received spectral range, the determined body part, the received body part, the determined at least one RoI, and/or the received at least one RoI.

Alternatively or in addition, determining the scope of analysis may comprise executing a large language model (LLM).

Determining the scope of analysis may be based on DICOM-headers or any other type of metadata saved in relation to the raw multispectral medical imaging data.

The metadata may be semantically analysed using the LLM. Thereby, the computer-implementation of the method may be improved.

The method may further comprise a step of providing the generated at least one medical image for rendering.

The rendering may be performed via a screen, such as a computer screen in a doctor's office or a screen in an operating theatre. Alternatively or in addition, the rendering may be performed using an XR headset or a HMD. The screen may be screen (e.g., a touchscreen) of a computing device, such as a PC, a mobile device and/or a tablet.

The rendering may comprise cinematic rendering. Cinematic rendering may comprise an image processing technique applied in medical diagnostics to create in particular three-dimensional (3D), photorealistic images of cross-sectional data, such as from CT or MRT.

Based on a volumetric Monte-Carlo Path Tracing algorithm, cinematic rendering may trace hundreds to thousands of light paths per voxel, or per pixel, through the data generated by a virtual camera. The light input may be averaged along these paths and transported from high-dynamic-range images back to the virtual camera sensor. The scattering, absorption and emission may then be simulated along the optical paths by the interaction between the light and the volumetric data, resulting in vivid, realistic anatomical images of similar image quality similar to computer generated imagery (CGI) sequences used in the film industry.

Approved for use in the medical field, cinematic rendering may be applied to a range of different areas that include radiology (to supplement available cross-sectional images), surgery (to plan preoperative procedures, such as oral and maxillofacial surgery, trauma surgery and orthopedics), as well as cardiovascular surgery and interventional radiology. Cinematic rendering can also be used across disciplines to, for example, train post-graduate medical personnel, as well as support patient education and interdisciplinary clinical meetings (such as tumor boards).

The method may comprise a step of receiving a user input indicative of a request to modify the rendering. The method may further comprise a step of changing at least one rendering parameter based on the received user input. The method may further comprise a step of providing the at least one medical image with at least one rendering parameter that has been changed for further rendering.

The rendering may be optimized, in particular interactively, for the scope of analysis based on the received user input.

The user input may comprise hoovering (e.g., over a RoI and/or a collection of pixels), zooming in or out, scrolling, performing a virtual reality (VR) rotation and/or performing a (in particular three-dimensional, 3D) flip. Alternatively or in addition, the user input may be indicative of introducing (and/or changing) a cut plane, and/or introducing (and/or changing) a split plane.

According to some examples, the rendering comprises providing a plurality of different rendering functions for rendering a medical image, selecting at least one rendering function from the plurality of different rendering functions based on the selected spectral map, and applying the selected at least one rendering function to the raw multispectral medical imaging data and/or or the spectral map for generating the at least one medica image.

The plurality of different rendering functions may respectively comprise a different transfer function for mapping raw imaging data or processed raw imaging data (which has been processed by applying the spectral map or which is the spectral map) to a two-dimensional image for displaying to a user. According to some examples, each transfer function may be associated to a particular one of the spectral maps or ranges. According to some examples each transfer function maps raw imaging data differently for different spectral ranges. With that, a rendering can be provided to the user which is suited for the spectral map/range.

According to some examples, the step of selecting the at least one spectral map comprises selecting a first spectral map and a second spectral map different from the first spectral map, the step selecting at least one rendering function comprises selecting a first rendering function based on the first spectral map and a second rendering function different from the first rendering function based on the second spectral map, and the step of applying the at least one rendering function comprises applying the first and the second rendering function to the raw multispectral medical imaging data and/or or the first/second spectral map for generating the at least one medical image.

Thereby, the step of applying may comprise applying the first rendering function to a first portion of the raw multispectral medical imaging data and/or or the first spectral map and the second rendering function to a second portion of the raw multispectral medical imaging data and/or or the second spectral map different from the first portion. According to some examples, the first portion may relate to a region of interest in the raw multispectral medical imaging data and/or or the first/second spectral map which may have been detected by the user or a detection tool. In particular, this may relate to a lesion visible in the raw multispectral medical imaging data and/or or the first/second spectral map.

Further, the step of applying may comprise rendering a first medical image with the first rendering function and a second medical with the second rendering function and merging and/or blending and/or overlaying the first and the second medical image so as to generate the at least one medical image.

That way, a medical image may be provided in which regions of interest are highlighted by way of basing their representation on a distinct spectral map.

Providing the medical image for rendering may comprise determining a hanging protocol and/or a reporting template.

Specifically, determining the hanging protocol may be based on the selected spectral map. Thereby, a plurality of preconfigured hanging protocols may be provided, wherein each of the plurality of preconfigured hanging protocols is associated with a spectral map and/or range, and the hanging protocol may be determined by selecting the determined hanging protocol from the plurality of hanging protocols based on the selected spectral maps. Specifically, the hanging protocol may be selected which fits the selected spectral map.

A hanging protocol may comprise a layout for a graphical user interface configured to present medical information and, in particular, one or more medical images to the user. With that, a layout can be determined which fits the spectral map.

According to further examples, the hanging protocol may be identified based on the scope of analysis (or may be or may be comprised in the scope of analysis) and indicate/require the usage of one or more spectral. For instance, a hanging protocol may set out having a medical image generated with a first spectral map and another image generated with a second spectral map different from the first spectral map.

Accordingly, the method may comprise determining a hanging protocol based on the scope of analysis and selecting the at least one spectral map based on the hanging protocol, wherein the hanging protocol indicates the at least one spectral map.

The hanging protocol and/or the reporting template may further facilitate the efficient workflow for the user (e.g., the medical practitioner), e.g., by selecting a hanging protocol and/or reporting template suitable for the scope of analysis.

Selecting the at least one spectral map to be generated may be based on a predefined configurable set of spectral maps. Alternatively or in addition, selecting the at least one spectral map to be generated may be rule-based, and/or based on a learned function.

Selecting the at least one spectral map to be generated may comprise selecting two or more spectral maps. The processing and/or generating of the at least one medical image (also: medical view) may comprise generating, e.g., one medical image associated with each spectral map, and/or generating a combination of the two or more spectral maps. Alternatively or in addition, the processing and/or generating of the at least one medical image may be based on the combination of the two or more spectral maps. Alternatively or in addition at least one combination image may be generated, e.g., with one part based on a first spectral map and another part based on a second map.

Selecting the at least one spectral map to be generated may comprise performing a segmentation on at least one of the at least one selected spectral map (e.g., on a first selected spectral map among two or more spectral maps).

A set of spectral maps may be predefined, from which one or more spectral maps for the scope of analysis may be selected.

The selecting may follow predefined rules, and/or may be computer-implemented based on a learned function, which may be trained based on historical data.

Two or more spectral maps can advantageously be used to distinguish between different diagnostic results. E.g., a lesion may be unequivocally identified by the selected combination of spectral maps, where the associated region in the medical image is conspicuous.

The rendering may be based on selecting at least one rendering parameter from a predefined configurable set of rendering parameters. Optionally, the selecting of the at least one rendering parameter may be based on the determined scope of analysis.

The rendering parameter may comprise a camera view, a cutting plane, a crop box, one or more sampling parameters, one or more interpolation parameters, one or more transfer functions for value to color and/or alpha mapping, color palettes, a material, a lighting, a depth value, an opacity, and/or texture coordinates, e.g., per voxel, or per pixel.

The processing may comprise selecting one or more (e.g., pre-processing, processing, and/or post-processing) tools from a predetermined set of (e.g., pre-processing, processing, and/or post-processing) tools based on the spectral map. The tools may have the ability to run completely autonomously and/or automatically.

According to some examples, each spectral map (of the plurality of preconfigured spectral maps) may be associated with one or more of the tools. By selecting the tools based on (or according to) the selected spectral map, those tools can be selected which are compatible with the respective map/spectral range.

The (e.g., pre-processing, processing, and/or post-processing) tool may, e.g., be a segmentation tool, a measurement tool, a reconstruction tool, and/or a visualisation relevant tool like masking through a segmentation.

The method may further comprise a step of providing a list of one or more (e.g., pre-processing, processing, and/or post-processing) tools. Alternatively or in addition, the method may further comprise a step of receiving a user input indicative of a selection of one or more (e.g., pre-processing, processing, and/or post-processing) tools.

The selecting of the (e.g., pre-processing, processing tools and/or post-processing) may in one embodiment be performed by a user (e.g., a medical practitioner) based on the scope of analysis.

In other embodiments, the selecting of the (e.g., pre-processing, processing, and/or post-processing) tools may be performed by the computing device.

According to some examples, the scope of analysis comprises obtaining a first predefined measurement parameter and a second predefined measurement parameter different from the first predefined measurement parameter, the step of selecting the at least one spectral map comprises selecting a first spectral map and a second spectral map different from the first spectral map, the method further comprises determining the first predefined measurement parameter based on the first spectral map and determining the second predefined measurement parameter based on the second spectral map. Further, the method may comprise providing the first and second predefined measurement parameters, preferably to a user and/or together with or in the at least one medical image. According to some examples, in the step of processing, a first medical image is generated based on the first spectral map and a second medical image is generated based on the second spectral map (from the raw multispectral medical imaging data, respectively) and first and second predefined measurement parameters are provided in both the first and second medical images. That way, a user can efficiently review the processing results.

The first and second predefined measurement parameters may be required to provide a certain clinical information or medical diagnosis as part of the scope of analysis. According to some examples, the first and second measurement parameters may be indicated by the scope of analysis. According, first and second measurement parameters may be obtained (or determined) bases on the scope of analysis. According to some examples, first and second predefined measurement parameters may be complementary measurement parameters. According to some examples, the first and second predefined measurement parameters may respectively relate to or are compatible with different spectral ranges or maps and/or can only be provided in the corresponding spectral range or map. According to some examples, the first measurement parameter may relate to an existence of a predetermined region of interest in the raw multispectral medical imaging data. According to some examples, the second measurement parameter may relate to one or more properties of the predetermined region of interest (as reflected in the raw multispectral medical imaging data). According to some examples, the region of interest may relate to a lesion in a body part of the patient.

The first spectral map may be selected (and/or generated) according to the first predefined measurement parameter. In particular, the first spectral map may be selected (and/or generated) so as to enable determining the first predefined measurement parameter from the raw multispectral medical imaging data. The second spectral map may be selected (and/or generated) according to the second predefined measurement parameter. In particular, the second spectral map may be selected (and/or generated) so as to enable determining the second predefined measurement parameter from the raw multispectral medical imaging data.

According to some examples, determining the first predefined measurement parameter may comprise processing the raw multispectral medical imaging data based on the first spectral map so as to generate a first mapping result and determining the first predefined measurement parameter based on the first mapping result. According to some examples, this may involve applying a first, in particular pre-processing, processing and/or post-processing, tool to the first mapping result. Further, determining the second predefined measurement parameter may comprise processing the raw multispectral medical imaging data based on the second spectral map so as to generate a second mapping result and determining the second predefined measurement parameter based on the second mapping result. According to some examples, this may involve applying a second, in particular pre-processing, processing and/or post-processing, tool different to the first tool to the second mapping result.

According to some examples, the first tool may be selected from a predetermined set of, in particular pre-processing, processing and/or post-processing, tools based on the first spectral map and/or the first predetermined measurement parameter and the second tool may be selected from the predetermined set of tools based on the second spectral map and/or the second predetermined measurement parameter.

The method may further comprise a step of receiving prior image data (briefly also: prior image(s)) and the step of selecting comprises selecting the at least one spectral map based on the prior image data.

The prior image data may comprise be prior (raw) multispectral medical imaging data or non-multispectral medical imaging data. Further, the prior image data may comprise one or more prior spectral maps and/or one or more medical images which may include rendered medical images.

According to some examples, the step of selecting may comprise analysing the spectral properties of the prior image data so as to provide a prior spectral information and selecting the at least one spectral map based on the prior spectral information. The prior spectral information may comprise any one of a spectral range, spectral map, spectral level, energy level or energy level.

With that, the spectral map can be selected so as to allow for a comparison of the processed raw multispectral medical imaging data with the prior image data (in additional consideration of the scope of analysis). In particular, a comparison may comprise registering the prior image data with the generated at least one spectral map, and/or registering the prior image data with the generated at least one medical image.

The method may further comprise a step of registering the prior image data with the generated at least one spectral map, and/or registering the prior image data with the generated at least one medical image. Optionally, the registering may comprise performing an optimization process. In particular, registering may comprise selecting the at least one rendering parameter for lowest uncertainty.

Using the registered prior image data, a progression of a patient's health state may be computed and verified.

The prior image data may be received before the processing of the raw multispectral medical imaging data (and/or before the processing of the at least one generated spectral map), e.g., on demand if the computing device (in particular automatically) and/or the user deems these to be necessary. Prior image data or prior results (e.g., extracted from these images) may alternatively or in addition have been stored for this purpose exactly.

In CT and/or MRT, (in particular image) voxels may (e.g., always) be the interesting part and/or relevant fundamental unit of the (e.g., raw multispectral) medical imaging data (e.g., for a RoI and/or as compared to pixels). E.g., CT slices comprise voxels because they represent a “true slice” of a given thickness of the body (briefly also: slice thickness). Pixels are used, e.g., in CT to describe the signals measured at the detector (in particular basically in single projections). Pixels may alternatively or in addition be relevant (in particular as the fundamental unit of the, e.g., raw multispectral, medical imaging data) for, e.g., X-ray imaging.

As to a device aspect, a computing device for generating a medical image from a spectral map generated from raw multispectral medical imaging data acquired via an energy-resolved medical imaging technique is provided. The computing device comprises a raw multispectral medical imaging data reception interface configured for receiving raw multispectral medical imaging data, which were acquired via an energy-resolved medical imaging technique. The computing device further comprises a determination module configured for determining a scope of analysis of the received raw multispectral medical imaging data. The computing device further comprises a selection module configured for selecting at least one spectral map. The selecting is based on the determined scope of analysis. The computing device still further comprises a processing module configured for processing the received raw multispectral medical imaging data for generating at least one medical image based on the at least one generated spectral map. Alternatively or in addition, the processing module may be configured for generating that at least one medical image from the at least one generated spectral map (e.g., by processing the at least one generated spectral map).

According to some examples, the computing device further comprises a generating module configured for generating the at least one selected spectral map from the raw multispectral medical imaging data.

The generating of the at least one medical image based on the at least one generated spectral map may be performed by a medical image generating module. Alternatively or in addition, the medical image generating module may be a sub-module of the processing module.

The computing device may be configured to perform any one of the steps, and/or comprise any one of the features, disclosed within the context of the method according to the method aspect.

As to a system aspect, a system for generating a medical image from a spectral map generated from raw multispectral medical imaging data acquired via an energy-resolved medical imaging technique is provided. The system comprises at least one medical scanner, which is configured for acquiring raw multispectral medical imaging data. The system further comprises a computing device according to the device aspect. The raw multispectral medical imaging data reception interface of the computing device is configured for receiving the raw multispectral medical imaging data from the at least one medical scanner. The system further comprises a display device (e.g., a computer screen), which is configured for rendering the generated at least one medical image.

As to a further aspect, a computer program product is provided comprising program elements which induce a computing device to carry out the steps of the method for generating a medical image from a spectral map generated from raw multispectral medical imaging data acquired via an energy-resolved medical imaging technique according to the method aspect, when the program elements are loaded into a memory of the computing device.

As to a still further aspect, a computer-readable medium is provided, on which program elements are stored that can be read and executed by a computing device, in order to perform steps of the method for generating a medical image from a spectral map generated from raw multispectral medical imaging data acquired via an energy-resolved medical imaging technique according to the method aspect, when the program elements are executed by the computing device.

The properties, features and advantages of this invention described above, as well as the manner they are achieved, become clearer and more understandable in the light of the following description and embodiments, which will be described in more detail in the context of the drawings.

This following description does not limit the present invention on the contained embodiments. Same components or parts can be labelled with the same reference signs in different figures. In general, the figures are not for scale.

It shall be understood that a preferred embodiment of the present invention can also be any combination of the dependent claims or above embodiments with the respective independent claim.

### BRIEF DESCRIPTION OF THE DRAWINGS

These and other aspects of the present invention will be apparent from and elucidated with reference to the embodiments described hereinafter.

FIG. 1 is a flow chart of a method for generating a medical image from a spectral map generated from raw multispectral medical imaging data acquired via an energy-resolved medical imaging technique according to a preferred embodiment of the present invention; and

FIG. 2 is an overview of the structure and architecture of a computing device for generating a medical image from a spectral map generated from raw multispectral medical imaging data acquired via an energy-resolved medical imaging technique according to a preferred embodiment of the present invention.

Any reference signs in the claims should not be construed as limiting the scope.

### DETAILED DESCRIPTION

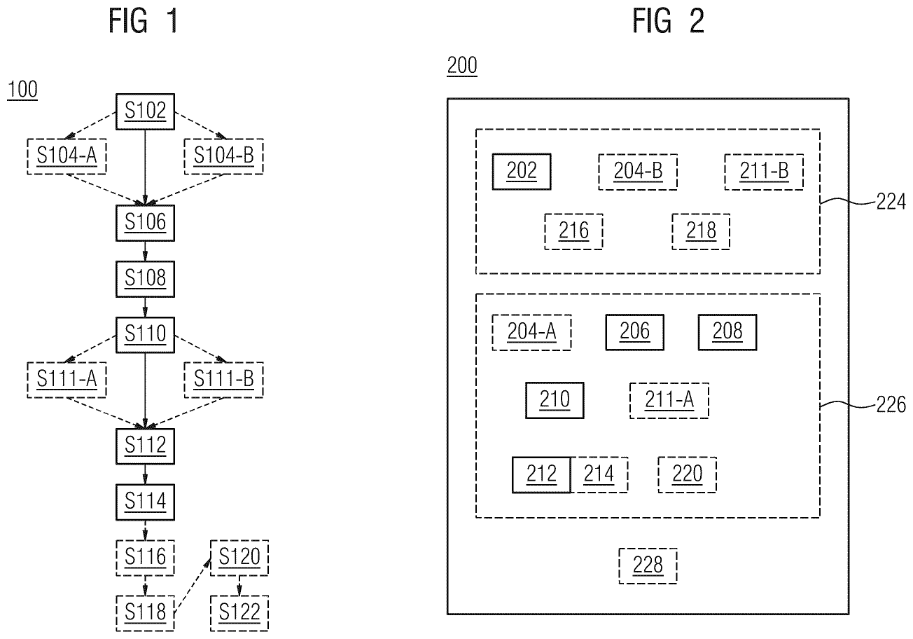

FIG. 1 schematically illustrates an exemplary flowchart for a computer-implemented method 100 for generating a medical image from a spectral map generated from raw multispectral medical imaging data acquired via an energy-resolved medical imaging technique.

The method 100 comprises a step S102 of receiving raw multispectral medical imaging data, which have been acquired via an energy-resolved medical imaging technique.

The method 100 further comprises a step S106 of determining a scope of analysis of the received S102 raw multispectral medical imaging data. The scope of analysis may be calculated from metadata of or associated to the raw multispectral medical imaging data, e.g. comprised in a DICOM header.

The method 100 further comprises a step S108 of selecting at least one spectral map to be generated from the received S102 raw multispectral medical imaging data. The selecting S108 is based on the determined S106 scope of analysis.

The method 100 further comprises a step S110 of generating the at least one selected S108 spectral map.

The method 100 still further comprises a step S112 of processing the received S102 raw multispectral medical imaging data for generating S114 at least one medical image based on the at least one generated S110 spectral map. In an alternative embodiment, the at least one medical image may be generated S114 by processing the generated S110 at least one spectral map.

Optionally, the method 100 may comprise a step S104-A of determining a spectral range, a body part and/or a region of interest (RoI) of the received S102 raw multispectral medical imaging data. Optionally, the determining S104-A may be based on metadata of the received S102 raw multispectral medical imaging data. Alternatively or in addition, the determining S104-A may be based on voxel data, or pixel data, of the received S102 raw multispectral medical imaging data. The determining S104-A may in particular be based on a machine-learned function.

Alternatively or in addition, the method 100 may comprise a step S104-B of receiving a user input indicative of a spectral range, a body part, and/or a RoI, of the received S102 raw multispectral medical imaging data.

The method 100 may comprise a step S111-A of providing a list of one or more processing (and/or pre-processing, and/or post-processing) tools. Alternatively or in addition, the method 100 may comprise a step S111-B of receiving a user input indicative of a selection of one or more processing (and/or pre-processing, and/or post-processing) tools.

The method 100 may comprise a step S116 of providing the generated S114 at least one medical image for rendering.

The method 100 may comprise a step S118 of receiving a user input indicative of a request to modify the rendering. The method 100 may further comprise a step S120 of changing at least one rendering parameter based on the received S118 user input. The method 100 may still further comprise a step S122 of providing the at least one medical image with at least one rendering parameter that has been changed S120 for further rendering.

The method 100 may comprise a step (not shown in FIG. 1) of receiving prior image data. The method 100 may further comprise a step (also not shown in FIG. 1) of registering the prior image data with the generated S110 at least one spectral map, and/or registering the prior image data with the generated S114 at least one medical image. Optionally, the registering may comprise performing an optimization process. In particular, registering may comprise selecting the at least one rendering parameter for lowest uncertainty.

The prior image data may be received before the step S112 of processing the received S102 raw multispectral medical imaging data. Alternatively or in addition, the prior image data may be received at the latest between the processing step S112 and the step S114 of generating at least one medical image. In a first exemplary embodiment, the prior image data may, e.g., be fetched on-demand latest before the step S114. In a second exemplary embodiment, the prior image data may alternatively or in addition have been stored and therefore be available at any time of performing the method 100.

The method 100 may be performed by the computing device 200 of the following FIG. 2.

FIG. 2 schematically illustrates an exemplary architecture of a computing device 200 for generating a medical image from a spectral map generated from raw multispectral medical imaging data acquired via an energy-resolved medical imaging technique.

The computing device 200 comprises a raw multispectral medical imaging data reception interface 202 configured for receiving raw multispectral medical imaging data. The raw multispectral medical imaging data were acquired via an energy-resolved medical imaging technique.

The computing device 200 further comprises a determination module 206 configured for determining a scope of analysis of the received raw multispectral medical imaging data.

The computing device 200 further comprises a selection module 208 configured for selecting at least one spectral map to be generated from the received raw multispectral medical imaging data, wherein the selecting is based on the determined scope of analysis.

The computing device 200 further comprises a generating module 210 configured for generating the at least one selected spectral map.

The computing device 200 still further comprises a processing module 212 configured for processing the received raw multispectral medical imaging data for generating at least one medical image based on the at least one generated spectral map. In an alternative embodiment, the at least one medical image may be generated by the processing module 212 by processing the generated at least one spectral map.

The generating of the at least one medical image based on the at least one generated spectral map may be performed by a medical image generating module 214. Alternatively or in addition, the medical image generating module 214 may be a sub-module of the processing module 212.

Optionally, the computing device 200 may comprise a spectral range determining module 204-A, which is configured for determining a spectral range, a body part and/or a RoI, of the received raw multispectral medical imaging data. Optionally, the determining may be based on metadata of the received raw multispectral medical imaging data, e.g. comprised in a DICOM header. Alternatively or in addition, the determining may be based on voxel data, or pixel data, of the received raw multispectral medical imaging data. The determining may in particular be based on a machine-learned function.

Alternatively or in addition, the computing device 200 may comprise a first user input reception interface 204-B configured for receiving a user input indicative of a spectral range, a body part, and/or a RoI, of the received raw multispectral medical imaging data.

The computing device 200 may comprise a processing tools providing module 211-A configured for providing a list of one or more processing (and/or pre-processing, and/or post-processing) tools.

Alternatively or in addition, the computing device 200 may comprise a second user input reception interface 211-B configured for receiving a user input indicative of a selection of one or more processing (and/or pre-processing, and/or post-processing) tools.

The computing device 200 may comprise a medical image provision interface 216 configured for providing the generated at least one medical image for rendering.

The computing device 200 may comprise a third user input reception interface 218 configured for receiving a user input indicative of a request to modify the rendering.

The computing device 200 may comprise a rendering parameter changing module 220 configured for changing the at least one rendering parameter based on the received user input.

The medical image provision interface 216 may be further configured for providing the at least one medical image with at least one rendering parameter that has been changed for further rendering.

The computing device 200 may comprise an input-output interface 224. The raw multispectral medical imaging data reception interface 202, the optional first user input reception interface 204-B, the optional second user input reception interface 211-B, the optional medical image provision interface 216, and/or the optional third user input reception interface 218 may be embodied by the input-output interface 224.

The computing device 200 may comprise a processor 226. The optional spectral range determining module 204-A, the determination module 206, the selection module 208, the generating module 210, the optional processing tools providing module 211-A, the processing module 212, the optional medical image generating module (or sub-module) 214, and/or the optional rendering parameter changing module 220 may be embodied by the processor 226.

The computing device 200 may comprise a memory 228. Within the memory 228, program elements may be stored for performing the steps of the method 100.

The computing device 200 may be configured for performing the method 100.

A system may comprise the computing device 200 and at least one medical scanner, which is configured for acquiring raw multispectral medical imaging data. The system may further comprise a display device, which is configured for rendering the generated at least one medical image. The system may be configured to perform the method 100.

The inventive technique (e.g., comprising the method 100, the computing device 200, and/or the system) may, according to a first embodiment, comprise a first step S102 of receiving a raw multispectral CT data set. Optionally, spectral ranges and one or more body parts depicted (also: imaged) may be determined from a DICOM header file (briefly: DICOM header), and/or directly from pixel data (e.g., by applying a machine-learned function).

A reason for the exam (and/or the reason for the acquisition of the raw multispectral medical imaging data) may be determined according to the step S106. This may comprise querying relevant data from a worklist, a scheduling system, and/or an EMR database and, optionally, using the spectral ranges or body part known for the CT data set. The data may comprise additional data relating to the patient, such a demographic data and/or the disease history. The step S106 may be performed by an LLM. Alternatively or in addition, one or more anatomy-aware algorithms may be used to determine the body part and/or more specific region (e.g., the at least one RoI) of the anatomic structure.

A pixel-based RoI can be more exact than data retrieved from meta data of the medical imaging data or from EMR database and/or EHR data sources. Data available in the selected and used CT protocol for the scan can convey further reason or patterns for the category of scan.

Further, this process (in particular the determining of the reason for the exam and/or the scope of analysis) may apply beforehand (e.g., as a prep step) potentially before any user interaction. Therefore, gaining speed by trying to predict what medical images will be most useful, and preparing the predicted medical images in advance, ready to be shown, can improve a medical (e.g., diagnostic and/or therapeutic) workflow.

One or more spectral maps are selected according to the reason for the exam in the step S108. This may also comprise selecting a combination of (e.g., two or more) spectral maps.

The raw multispectral CT data are processed in the step S112 so as to generate S114 images respectively according to the selected S108 spectral maps.

A visualization may be generated based on the images. This may include generating combination images with one part based on a first spectral map and another part based on a second map. This may involve applying a segmentation tool to one image (e.g., representing the first map) to obtain segmented image data and use the segmented image data when generating the visualization of another image (e.g., representing the second map). The segmentation may be selected based on the reason for the exam (and/or based on the scope of analysis). Visualization may comprise cinematic rendering.

A mapping from the information collected in the processing step S112 to a predefined configurable set of spectral maps and rendering options may be used (such as for automatically generating the most likely visualizations).

Multiple representations may be shown interactively at once. In a first embodiment, multiple representations may be shown when hovering over some region (e.g., RoI) and/or pixel, enabling this view ad-hoc, e.g., on shortcut or in a lens-like tool. In a second embodiment, scrolling and/or performing a VR (also: VRT) Rotation, and/or showing measurements may be enabled through all representations. In a third embodiment, one or flips in 3D (e.g., on Apple and/or Windows operating systems) are enabled for showing multiple representations at once. In a fourth embodiment, one or more 3D orthogonal cut planes are sued, each showing a different representation. In a fifth embodiment, a 3D visualization with split plane (e.g., like 3d neuro) showing different representations on each half-space is used. All of the above embodiments may be combined with each other.

Optionally, one or more image processing (and/or pre-processing, and/or post-processing) tools may be selected and applied for each (e.g., to be) generated medical image (e.g., in the step S112). Processing (and/or pre-processing, and/or post-processing) tools may generally be configured to detect medical findings in the medical imaging data. Image processing (and/or pre-processing, and/or post-processing) tools may be specific for (or to) a certain spectral map and/or may work best for a certain spectral map. Therefore, the step of selecting and applying one or more processing (and/or pre-processing, and/or post-processing) tools may also include the feeding of the most appropriate spectral map to the selected tool (e.g., rule-based and/or with a machine-learned function).

Optionally, a hanging protocol and/or one or more reporting templates may be determined (e.g., in the step S116) based on the spectral maps selected (e.g., in the step S108).

Optionally, longitudinal data may be used. Prior image data may be registered with the multispectral CT-data set for follow-up reading. The different spectral maps may be inherently registered. This enables to separately using them for registering with a prior study (which, e.g., need not be, or may be not, multispectral, or no CT dataset at all). Specifically, different representations may be used for registration with the prior data and the best (e.g., with the lowest uncertainty) for the final registration of the multispectral CT-data with the prior image data. Alternatively or in addition, the individual registrations may be aggregated in an optimization process.

According to a second embodiment, a raw multispectral CT data set is received in the step S102. Optionally, spectral ranges and one or more body parts depicted (and/or imaged) are determined from a DICOM header file (and/or DICOM header) and/or directly from pixel data (e.g., by applying a machine-learned function).

An image processing task is received from the user (e.g., a radiologist or other medical practitioner). Receiving the image processing task may comprise a command such as “show me the liver and liver lesions”. The command may be implicitly input (e.g., by opening a liver case) and/or explicitly input, such as by activating a tool and/or inputting natural language.

One or more spectral maps may be selected (e.g., In the step S108) according to the task. This selection S108 can be done rule-based (e.g., “liver analysis=>iodine map and low kV image”), and/or using more elaborated learned functions.

One or more spectral images may be generated S114 according to the selected S108 spectral maps.

One or more image processing tools may be selected (e.g., for the processing step S112) based on the task and the spectral maps and/or images.

The image processing (and/or pre-processing, and/or post-processing) tools may be applied (e.g., in the processing step S112) to the one or more medical images, and/or may be suggested for use to a clinical user (e.g., by displaying only this tool selection in a tool menu).

Different (e.g., pre-processing, processing, and/or post-processing) tools may be applied to different (in particular raw multispectral) medical imaging data, and/or to different medical images (in particular to be generated). Generally, a combination of (e.g., pre-processing, processing, and/or post-processing) tools may be required to successfully complete a task. For instance, a segmentation mask may be defined in (or for) a medical image, the spectrum of which is best suited to do so, and the segmentation mask may be transferred to another medical image, the spectrum of which is best suited to determine lesions within the mask.

The task may be completed based on the image processing (and/or pre-processing, and/or post-processing) results.

Independent of the grammatical term usage, individuals (e.g., patients and/or humans) with male, female or other gender identities are included within the term.

Wherever not already described explicitly, individual embodiments, or their individual aspects and features, described in relation to the drawings can be combined or exchanged with one another without limiting or widening the scope of the described invention, whenever such a combination or exchange is meaningful and in the sense of this invention. Advantages which are described with respect to a particular embodiment of present invention or with respect to a particular figure are, wherever applicable, also advantages of other embodiments of the present invention.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

What is claimed is:

1. A computer-implemented method, performed by a computing device, for generating a medical image from a spectral map generated from raw multispectral medical imaging data acquired via an energy-resolved medical imaging technique, the computer-implemented method comprising:
receiving raw multispectral medical imaging data, the raw multispectral medical imaging data having been acquired via an energy-resolved medical imaging technique;
determining a scope of analysis of the raw multispectral medical imaging data;
selecting at least one spectral map based on the scope of analysis; and
processing the raw multispectral medical imaging data to generate at least one medical image based on the at least one spectral map.

2. The computer-implemented method according to claim 1, wherein the energy-resolved medical imaging technique includes:
computed tomography;
magnetic resonance tomography;
photoacoustic medical imaging;
dual-energy digital X-ray imaging;
photon-counting X-ray imaging; or
energy-resolved neutron imaging.

3. The computer-implemented method according to claim 1, further comprising at least one of:
determining at least one of a spectral range, a body part or a region of interest of the raw multispectral medical imaging data; or
receiving a user input indicative of at least one of the spectral range, the body part, or the region of interest of the raw multispectral medical imaging data.

4. The computer-implemented method according to claim 1, wherein determining the scope of analysis comprises at least one of:
analysing metadata in relation to the raw multispectral medical imaging data;
using a spectral range, a body part or a region of interest of the raw multispectral medical imaging data; or
executing a large language model on the metadata of the raw multispectral medical imaging data.

5. The computer-implemented method according to claim 1, further comprising:
providing the at least one medical image for rendering.

6. The computer-implemented method according to claim 5, wherein the rendering comprises:
providing a plurality of different rendering functions for rendering the at least one medical image,
selecting at least one rendering function from the plurality of different rendering functions based on the at least one spectral map, and
applying the at least one rendering function to at least one of the raw multispectral medical imaging data or the at least one spectral map to generate the at least one medical image.

7. The computer-implemented method according to claim 6, wherein
selecting the at least one spectral map includes selecting a first spectral map and a second spectral map, the second spectral map being different from the first spectral map,
selecting the at least one rendering function includes selecting a first rendering function and a second rendering function, the second rendering function being different from the first rendering function, and
applying the at least one rendering function includes applying the first rendering function and the second rendering function to at least one of the raw multispectral medical imaging data or the at least one spectral map to generate the at least one medical image.

8. The computer-implemented method according to claim 5, wherein providing the at least one medical image for rendering comprises:
determining a hanging protocol based on the at least one spectral map.

9. The computer-implemented method according to claim 1, wherein selecting the at least one spectral map at least one of:
is based on a configurable set of spectral maps;
is at least one of rule-based or based on a learned function;
includes selecting two or more spectral maps, wherein at least one of (i) processing the at least one medical image includes generating a combination of the two or more spectral maps, or (ii) processing the at least one medical image is based on a combination of the two or more spectral maps; or
includes performing a segmentation on at least one of the at least one spectral map.

10. The computer-implemented method according to claim 5, wherein the rendering is based on selecting at least one rendering parameter from a configurable set of rendering parameters.

11. The computer-implemented method according to claim 1, wherein processing the raw multispectral medical imaging data comprises:
selecting one or more tools from a set of tools based on the at least one spectral map.

12. The computer-implemented method according to claim 1, wherein
the scope of analysis includes determining a first measurement parameter and a second measurement parameter, the second measurement parameter being different from the first measurement parameter,
selecting the at least one spectral map includes selecting a first spectral map and a second spectral map, the second spectral map being different from the first spectral map, and
the computer-implemented method further includes determining the first measurement parameter based on the first spectral map and determining the second measurement parameter based on the second spectral map.

13. The computer-implemented method according to claim 1, further comprising at least one of:
providing a list of one or more tools; and
receiving a user input indicative of a selection of one or more tools from the list of one or more tools.

14. The computer-implemented method according to claim 1, further comprising:
receiving prior image data; wherein
the at least one spectral map is selected based on the prior image data.

15. A computing device for generating a medical image from a spectral map generated from raw multispectral medical imaging data acquired via an energy-resolved medical imaging technique, the computing device comprising:
a raw multispectral medical imaging data reception interface configured to receive raw multispectral medical imaging data, the raw multispectral medical imaging data having been acquired via an energy-resolved medical imaging technique;
a determination module configured to determine a scope of analysis of the raw multispectral medical imaging data;
a selection module configured to select at least one spectral map based on the scope of analysis; and
a processing module configured to process the raw multispectral medical imaging data to generate at least one medical image based on the at least one spectral map.

16. A computing device configured to perform the computer-implemented method according to claim 2.

17. A system for generating a medical image from a spectral map generated from raw multispectral medical imaging data acquired via an energy-resolved medical imaging technique, the system comprising:
at least one medical scanner configured to acquire raw multispectral medical imaging data;
the computing device according to claim 15, wherein the raw multispectral medical imaging data reception interface is configured to receive the raw multispectral medical imaging data from the at least one medical scanner; and
a display device configured to render the at least one medical image.

18. The computer-implemented method of claim 2, wherein the computed tomography is photon-counting computed tomography.

19. The computer-implemented method according to claim 3, wherein at least one of
the determining is based on metadata of the raw multispectral medical imaging data, or
the determining is based on a machine-learned function and voxel data, or pixel data, of the raw multispectral medical imaging data.

20. The computer-implemented method according to claim 4, wherein the metadata is from at least one of a worklist, a scheduling system, a scan protocol, an electronic medical record database, demographic data or is in relation to a disease history.

21. The computer-implemented method according to claim 10, wherein selecting the at least one rendering parameter is based on the scope of analysis.

22. The computer-implemented method according to claim 11, wherein the set of tools include at least one of pre-processing, processing or post-processing tools.

23. The computer-implemented method according to claim 13, wherein the list of one or more tools includes at least one of pre-processing, processing, or post-processing tools.
